(19) United States
(12) Patent Application Publication
(10) Pub. No.: US 2006/0049586 A1
(43) Pub. Date: Mar. 9, 2006

(54) Tool bit adapter for reciprocating pneumatic tool

(76) Inventor: Kuo-Jung Leu, Taichung County (TW)

Correspondence Address: BACON & THOMAS, PLLC, 625 SLATERS LANE, FOURTH FLOOR, ALEXANDRIA, VA, 22314, US

(21) Appl. No.: 11/199,224

(22) Filed: Aug. 9, 2005

(30) Foreign Application Priority Data
Aug. 17, 2004 (TW) 93213112

(51) Int. Cl. B25D 11/00

(52) U.S. Cl. 279/19.1; 173/132

(57) ABSTRACT

A tool bit adapter installed in a reciprocating pneumatic tool for locking a tool bit to an impact cylinder of the pneumatic tool is disclosed to include a socket fastened to the impact cylinder of the pneumatic tool, a stop member movably mounted on the socket, the stop member having a stop portion and an engagement space movable between a locking position to lock a tool bit to the impact cylinder and an unlocking position to let the user remove the tool bit from the impact cylinder, and a spring member coupled between the socket and the stop member to hold the stop member in the locking position.

### BACKGROUND OF THE INVENTION

1. Field of the Invention

The present invention relates to pneumatic tools and more particularly, to a tool bit adapter for use in a reciprocating pneumatic tool to couple a tool bit to an impact cylinder of the pneumatic tool.

2. Description of the Related Art

When a tool bit is installed in a conventional reciprocating pneumatic tool, a helical spring is fastened to an impact cylinder to lock the tool bit. The helical spring has a hooked portion at the front side for stopping the installed tool bit in place. During installation, the user must rotate the helical spring through several turns so that the helical spring can hold the tool bit firmly in place. When unloading the tool bit, the user must rotate the helical spring in the reversed direction. This mounting and/or dismounting procedure is complicated, wasting much time. Further, the hooked portion of the helical spring tends to be deformed accidentally by an external object, resulting in falling of the tool bit from the pneumatic tool.

### SUMMARY OF THE INVENTION

The present invention has been accomplished under the circumstances in view. It is the main object of the present invention to provide a tool bit adapter, which allows quick change of the tool bit, saving much tool bit mounting and/or dismounting time. It is another object of the present invention to provide a tool bit adapter, which has a simple structure that is easy to install and to operate.

To achieve these and other objects of the present invention, the tool bit adapter is installed in a reciprocating pneumatic tool and adapted to lock a tool bit to an impact cylinder of the pneumatic tool, comprising: a socket, the socket having a socket body and mounting means for fastening the socket body to the impact cylinder of the pneumatic tool; a stop member movably mounted on the socket, the stop member having a stop portion and an engagement space movable between a locking position for locking the tool bit to the impact cylinder and an unlocking position for enabling the installed tool bit to be removed from the impact cylinder; and a spring member coupled between the socket and the stop member to hold the stop member in the locking position.

### BRIEF DESCRIPTION OF THE DRAWINGS

FIG. 1 is a schematic drawing showing a tool bit adapter installed in a reciprocating pneumatic tool according to the present invention.

FIG. 2 is a sectional assembly view of the tool bit adapter according to the present invention.

FIG. 3 is an exploded plain view of the tool bit adapter according to the present invention.

FIG. 4 is a side view of the stop member shown in FIG, 3.

FIG. 5 corresponds to FIG. 1 showing the stop member unlocked from the tool bit.

FIG. 6 shows the socket formed integral with the impact cylinder according to the present invention.

FIG. 7 shows the structure of the coiled portion of the stop member according to the present invention.

FIG. 8 is a front assembly view of an alternate form of the tool bit adapter according to the present invention.

FIG. 9 is a side assembly view of another alternate form of the tool bit adapter according to the present invention.

FIG. 10 is a front assembly view of still another alternate form of the tool bit adapter according to the present invention.

FIG. 11 is a front assembly view of still another alternate form of the tool bit adapter according to the present invention.

FIG. 12 illustrates the structure of the stop member shown in FIG. 11.

FIG. 13 is a schematic drawing showing still another alternate form of the tool bit adapter according to the present invention.

### DETAILED DESCRIPTION OF THE INVENTION

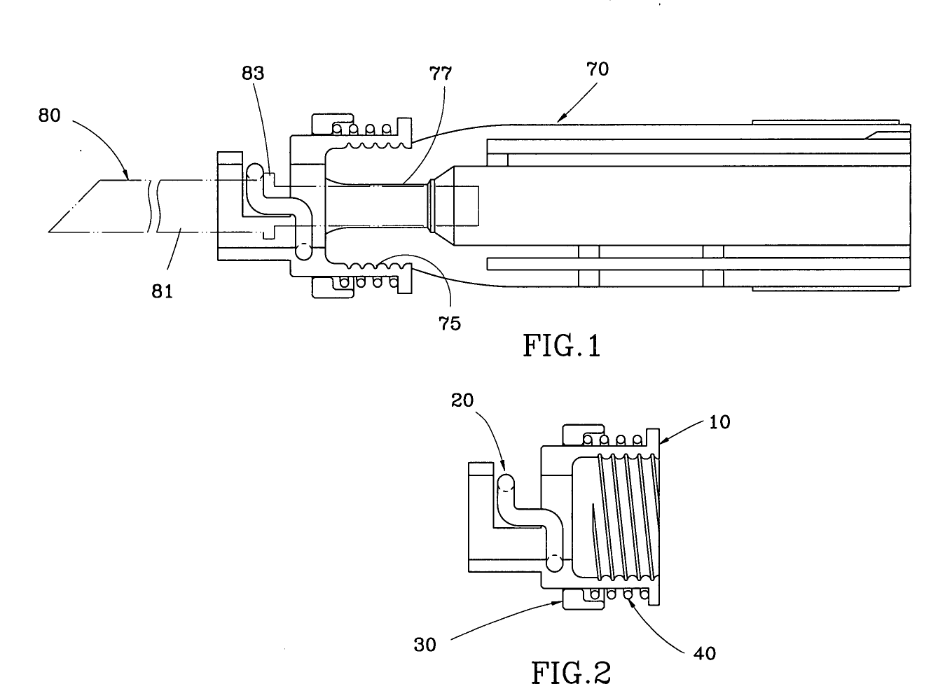

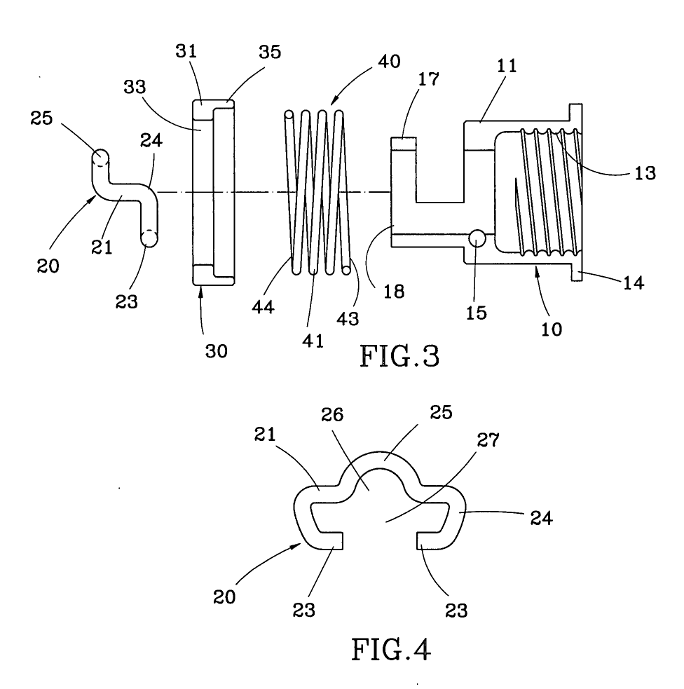

Referring to FIG. 1, a tool bit adapter is connectable to an impact cylinder 70 of a reciprocating pneumatic tool for holding a tool bit 80.

The impact cylinder 70 has a threaded neck 75 and an axial insertion hole 77 axially extending through the threaded neck 75. The tool bit 80 has a shank 81 and a stop flange 83 around the periphery of the shank 81.

Referring to FIGS. 2˜4 and FIG. 1 again, the aforesaid tool bit adapter comprises a socket 10, a stop member 20, a control cap 30, and a spring member 40.

The socket 10 has a hollow socket body 11, a mounting portion 13, for example, an inner thread provided inside the socket body 11 for threaded onto the threaded neck 75 of the impact cylinder 70, a stop flange 14 extending around the periphery of one end, namely, the rear end of the socket body 11, two pivot holes 15 symmetrically provided at two sides of the socket body 11 near the other end, namely, the front end of the socket body 11, a bumper 17 extending from the front side of the socket body 11, and an axle hole 18 axially extending through the front side of the socket body 11 for protecting the stop member 20 from being bumped.

The stop member 20 according to this embodiment is formed of a curved wire rod, having two bearing portions 21, two pivot tips 23 respectively pivoted to the pivot holes 15 of the socket 10, two spring arms 24 respectively connected between the bearing portions 21 and the pivot tips 23, a stop portion 25 of arch frame connected between the bearing portions 21 remote from the spring arms 24, an engagement space 26 surrounded by the stop portion 25, and a receiving space 27 surrounded by the spring arms 24 and the bearing portions 21 in communication with the engagement space 26 at the lower side.

The control cap 30 has a cap body 31 capped on the socket body 11 of the socket 10, a through hole 33 formed in the cap body 31 for the passing of the socket body 11 of the socket 10, and a cap flange 35 extending around the periphery of the cap body 31 and surrounding a part of the spring member 40.

The spring member 40 according to this embodiment is a compression spring, having a spring body 41 sleeved onto the socket body 11 of the socket 10, a first end 43 stopped against the stop flange 14 of the socket 10, and a second end 44 stopped against the cap body 31 of the control cap 30.

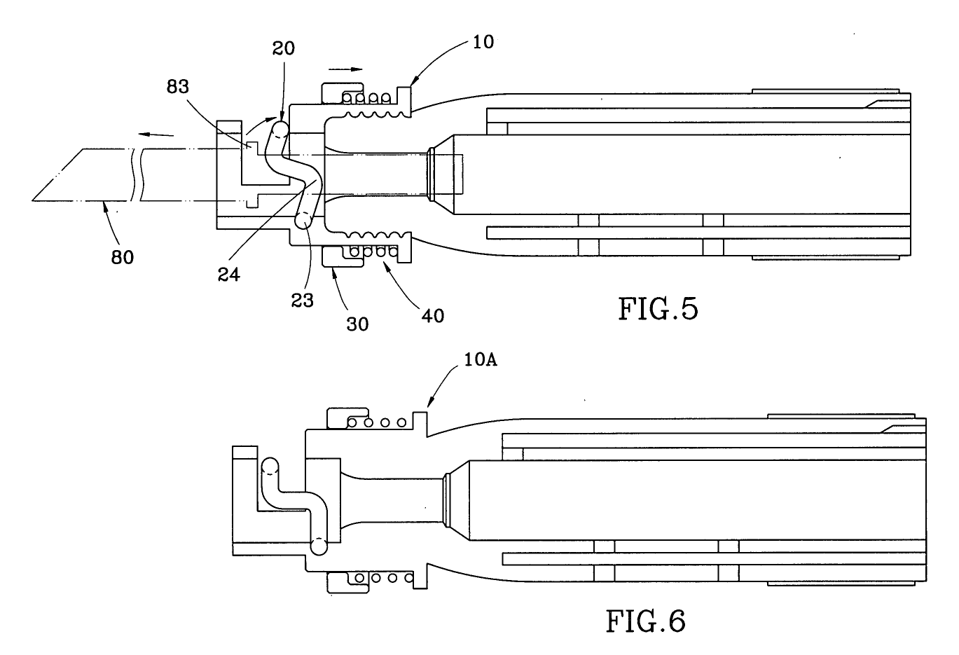

Referring to FIG. 5 and FIG. 1 again, when pulling the control cap 30 backwards, the stop member 20 is biased in one direction. At this time, the engagement space 26 of the stop member 20 is deviated from the centerline of the impact cylinder 70, allowing insertion of the tool bit 80 into the impact cylinder 70 through the receiving space 27 of the stop member 20 and forming an unlocking position. After insertion of the shank 81 of the tool bit 80 into the axial insertion hole 77 of the impact cylinder 70, the control cap 30 is released from the hand, enabling the control cap 30 to be pushed forwards to its former position by the spring member 40 to further return the stop member 20 to its former position, thereby causing the stop portion 25 and engagement space 26 of the stop member 20 to be held in positive engagement with the stop flange 83 of the tool bit 80 and forming an locking position, therefore the tool bit 80 is locked to the impact cylinder 70.

FIG. 6 shows an alternate form of the present invention. According to this embodiment, the socket 10A is a part of the impact cylinder, i.e., the socket 10A can be formed integral with the impact cylinder or fixedly fastened to the impact cylinder.

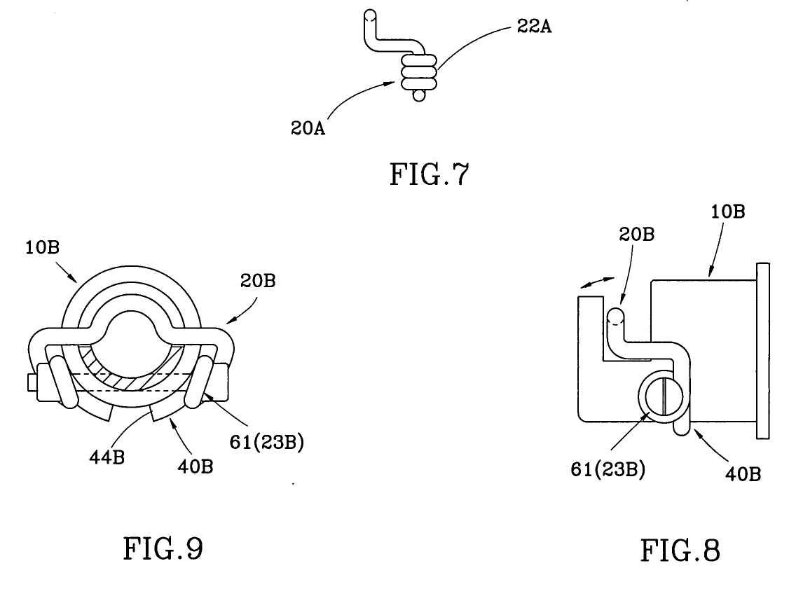

FIG. 7 shows another alternate form of the present invention. According to this embodiment, the stop member 20A has a coiled portion 22A that enhances the springy power of the stop member 20A.

FIGS. 8 and 9 show still another alternate form of the present invention. The tool bit adapter according to this embodiment is comprised of a socket 10B, a stop member 20B, and a spring member 40B. The spring member 40B is a torsional spring formed integral with the stop member 20B. The stop member 20B has two pivot holes 23B pivotally connected to the socket 10B with a pivot bolt 61. The spring member 40B has a second stop portion 44B stopped at a part of the socket 10B. Alternatively, the stop member 20B and the spring member 40B can be two independent members fastened together.

Further, the stop member in either of the aforesaid various alternate forms of the present invention can be made having a handle for operating by the user's hand, i.e., for pulling or pushing by the user to move the stop member to the locking or unlocking position.

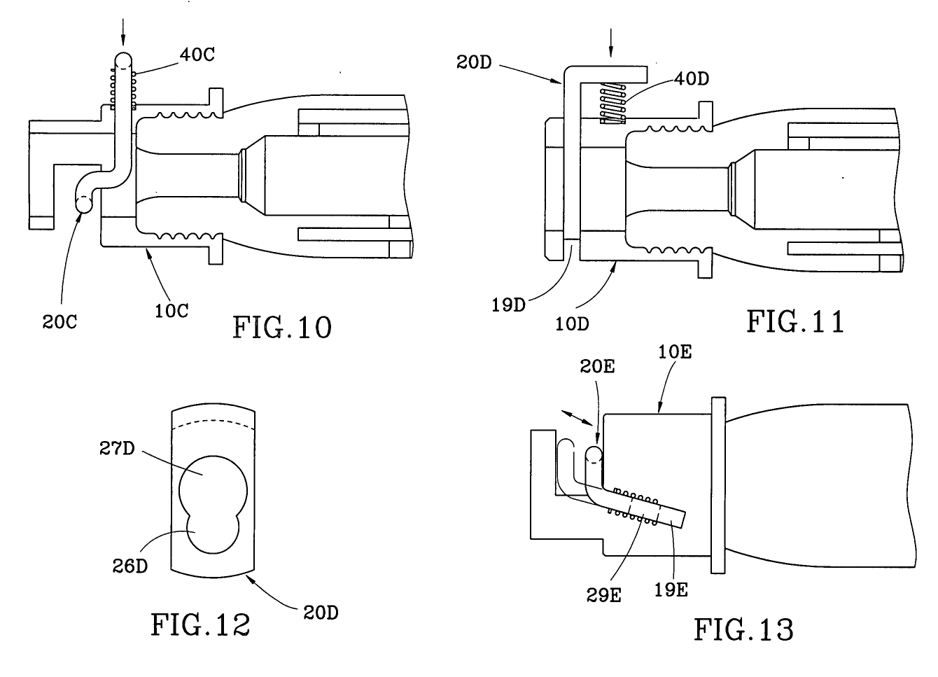

FIG. 10 shows still another alternate form of the present invention.

According to this embodiment, the stop member 20C is slidably mounted on the socket 10C, and the spring member 40C is supported between the stop member 20C and the socket 10C. According to this embodiment, the user can press the stop member 20C vertically downwards from the locking position to the unlocking position for allowing installation of the tool bit. When released the hand from the stop member 20C after insertion of the tool bit into the impact cylinder, the spring member 40C pushes the stop member 20C upwards from the unlocking position to the locking position.

FIGS. 11 and 12 show still another alternate form of the present invention. According to this embodiment, the stop member 20D is formed of a plate member, having an engagement space 26D and a receiving space 27D in communication with the engagement space 26D at the upper side; the socket 10D has a coupling groove 19D for receiving the engagement space 26D of the stop member 20D to hold the stop member 20D in the locking position.

The stop member of aforesaid two embodiments still can be operated by pulling action instead and moved to the unlocking position.

FIG. 13 shows still another alternate form of the present invention. According to this embodiment, the socket 10E has two upwardly forwardly extending sliding grooves 19E at two sides; the stop member 20E has two coupling portions 29E respectively coupled to the sliding grooves 19E of the socket 10E.

As indicated above, the invention provides a tool bit adapter for reciprocating pneumatic tool, which has the following advantages:
1. The tool bit adapter allows quick change of the tool bit, saving much tool bit mounting and/or dismounting time.
2. The tool bit adapter has a simple structure that is easy to install and to operate.

What is claimed is:

1. A tool bit adapter installed in a reciprocating pneumatic tool and adapted to lock a tool bit to an impact cylinder of said pneumatic tool, said tool bit adapter comprising:
a socket, said socket having a socket body and mounting means for fastening said socket body to said impact cylinder of said pneumatic tool;
a stop member movably mounted on said socket, said stop member having a stop portion and an engagement space movable between a locking position for locking said tool bit to said impact cylinder and an unlocking position for enabling said installed tool bit to be removed from said impact cylinder; and
a spring member coupled between said socket and said stop member to hold said stop member in said locking position.

2. The tool bit adapter as claimed in claim 1, wherein said socket is formed integral with a part of said impact cylinder.

3. The tool bit adapter as claimed in claim 1, wherein said stop member is pivoted to said socket and biasable relative to said socket within a predetermined angle between said locking position and said unlocking position.

4. The tool bit adapter as claimed in claim 1, further comprising a control cap slidably mounted on said socket and supported between said stop member and said spring member.

5. The tool bit adapter as claimed in claim 1, wherein said spring member is a torsional spring.

6. The tool bit adapter as claimed in claim 1, wherein said stop member and said spring member are formed integral with each other.

7. The tool bit adapter as claimed in claim 1, wherein said stop member is slidably mounted on said socket and axially movable between said locking position and said unlocking position.

8. The tool bit adapter as claimed in claim 1, wherein said socket has a bumper for protecting said stop member from being bumped.

9. The tool bit adapter as claimed in claim 1, wherein said stop member is formed of a curved wire rod.

10. The tool bit adapter as claimed in claim 1, wherein said stop member is formed of a plate member.
